(19) United States
(12) Patent Application Publication
(10) Pub. No.: US 2024/0319421 A1
(43) Pub. Date: Sep. 26, 2024

(54) DUAL PASS BAND FILTER ELEMENT

(71) Applicant: VACTRONICS TECHNOLOGIES INC., MIAOLI COUNTY (TW)

(72) Inventors: Sen-Tsung HSIAO, MIAOLI COUNTY (TW); Hsang-Yang LIN, MIAOLI COUNTY (TW); Hung-Jen PAN, MIAOLI COUNTY (TW); Ping-Yuan CHEN, MIAOLI COUNTY (TW)

(21) Appl. No.: 18/610,300

(22) Filed: Mar. 20, 2024

(30) Foreign Application Priority Data
Mar. 21, 2023 (TW) 112110371

(51) Int. Cl. G02B 5/28

(52) U.S. Cl. CPC G02B 5/281

(57) ABSTRACT

A dual pass band filter element includes: a substrate, and a bandpass filtering structure and an anti-reflection structure formed on two opposite surfaces of the substrate. The bandpass filtering structure includes a plurality of first material layers and a plurality of second material layers with a refractive index higher than the respective first material layers, wherein the first and second material layers are stacked alternately along the normal of the substrate; the dual pass band filter element has a first pass band and a second pass band that does not overlap with the first pass band in a band of 400 nm to 1800 nm. In this way, two different bands of light are allowed to pass through the dual pass band filter element, thereby expanding the application field of the dual pass band filter element.

### BACKGROUND

### Field of the Invention

The present invention relates to an optical filter, and more particularly to a dual-passband optical filter.

### Description of Related Art

With the advancement of technology, the requirements for electronic devices that use optical components are becoming increasingly diverse and demanding, such as but not limited to lightweight and multifunctional dimensions. However, existing filter elements only have a bandpass that allows a specific band of light to pass through. If an electronic device needs to operate in two different bands, two types of filter elements need to be configured to meet the demand, resulting in an increase in the volume of the electronic device.

### SUMMARY

For this purpose, the objective of the present invention is to provide a dual pass band filter element that can overcome the problem of conventional filter elements only allowing a single specific band of light to pass through.

A dual pass band filter element provided by the present invention includes: a substrate with a first surface and a second surface opposite the first surface; a bandpass filtering structure formed on the first surface and including a plurality of first material layers and a plurality of second material layers with a refractive index higher than the respective first material layers, wherein the first and second material layers are stacked alternately along a normal of the substrate; and an anti-reflection structure formed on the second surface; wherein the dual pass band filter element has a first pass band and a second pass band that does not overlap with the first pass band in a band of 400 nm to 1800 nm.

Optionally, in the bandpass filtering structure, a film layer closest to the first surface and a film layer farthest from the first surface are both the first material layers.

Optionally, a thickness of a film layer farthest from the first surface is the same as that of a film layer closest to the first surface in the bandpass filtering structure.

Optionally, thicknesses of the first material layers in the bandpass filtering structure are 5.34 nm-205.21 nm.

Optionally, thicknesses of the second material layers in the bandpass filtering structure are 19.96 nm-269.93 nm.

Optionally, in the bandpass filtering structure, thicknesses of the first material layers are 0.02-10.28 times thicknesses of the second material layers.

Optionally, in the bandpass filtering structure, a thickness of each of the first material layers is 0.04-9.43 times or 0.07-4.37 times a thickness of one of the second material layers adjacent to this first material layer.

Optionally, the number of film layers of the bandpass filtering structure is 5.7 times that of the anti-reflection structure.

Optionally, the anti-reflection structure includes at least one third material layer and at least one fourth material layer, the at least one third material layer and the at least one fourth material layer are stacked along the normal, a material of the third material layer is the same as that of the first material layer, a material of the fourth material layer is the same as that of the second material layer, and in the anti-reflection structure, a film layer closest to the second surface and a film layer farthest from the second surface are both the third material layers.

Optionally, the anti-reflection structure includes at least one third material layer and at least one fourth material layer, the at least one third material layer and the at least one fourth material layer are stacked along the normal, a material of the third material layer is the same as that of the first material layer, a material of the fourth material layer is the same as that of the second material layer, and in the anti-reflection structure, a thickness of a film layer closest to the second surface is the same as that of a film layer farthest from the second surface.

Optionally, the anti-reflection structure includes at least one third material layer and at least one fourth material layer, the at least one third material layer and the at least one fourth material layer are stacked along the normal, a material of the third material layer is the same as that of the first material layer, a material of the fourth material layer is the same as that of the second material layer, a thicknesses of a film layer farthest from the first surface is the same as that of a film layer closest to the first surface in the bandpass filtering structure, and in the anti-reflection structure, a thickness of a film layer closest to the second surface is the same as that of a film layer furthest from the second surface.

Optionally, the anti-reflection structure includes at least two third material layers and at least one fourth material layer, the at least two third material layer and the at least one fourth material layers are stacked along the normal, a material of the third material layer is the same as that of the first material layer, a material of the fourth material layer is the same as that of the second material layer, and in the anti-reflection structure, a pair of film layers furthest away from the second surface and stacked together are the third material layers.

Therefore, the dual pass band filter element provided by the present invention can allow two different bands of light to pass through, thereby expanding the application field of the dual pass band filter element.

### BRIEF DESCRIPTION OF THE DRAWINGS

Other aspects of the present invention and its advantages will be discovered after a detailed description is studied in conjunction with the following attached drawings:

FIG. 1 is a structural diagram of a dual pass band filter element according to an embodiment of the present invention; and

FIG. 2 is a schematic diagram shows the spectral curve of the bandpass filtering structure of the dual pass band filter element in FIG. 1 under a transmittance test at an incident angle of 0 degree.

### DETAILED DESCRIPTION

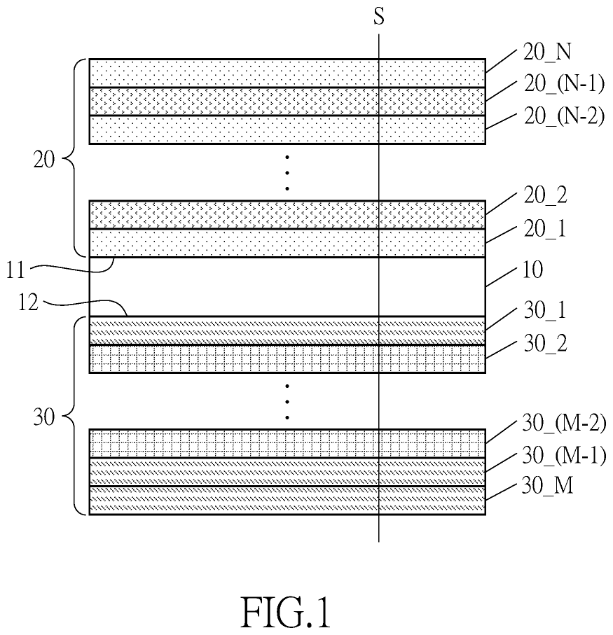

Please refer to FIG. 1, a dual pass band filter element provided by the present invention according to an embodiment can be applied to laser or optical communication devices operating in long bands. The dual pass band filter element includes a substrate 10, a bandpass filtering structure 20, and an anti-reflection structure 30.

The substrate 10, for example, can be, but not limited to a transparent glass substrate, having a first surface 11 and a second surface 12 opposite the first surface 11. The bandpass filtering structure 20 is formed on the first surface 11, and the anti-reflection structure 30 is formed on the second surface 12. The dual pass band filter element has a first pass band and a second pass band that does not overlap with the first pass band in a band of 400 nm to 1800 nm.

The bandpass filtering structure 20 includes film layers 20_1-20_N, where N is a positive integer greater than or equal to 3, such as but not limited to 57. The film layers 20_1-20_N include at least two first material layers and at least one second material layer with a refractive index higher than the respective first material layers. The first material layer is made of, such as, but not limited to, silicon dioxide (SiO2), and has an absorption coefficient of less than 1e-5 in a band greater than 900 nm. The second material layer is made of, such as, but not limited to, hydrogen-doped silicon (represented by Si—H below), has an absorption coefficient of less than 1.386e-4 in a band greater than 900 nm. These first and second material layers are stacked alternately along the normal S of the substrate 10.

The thickness of the first material layers in the bandpass filtering structure 20, for example, but not limited to, is approximately 5.34 nm-205.21 nm.

The thickness of the second material layer in the bandpass filtering structure 20, for example, but not limited to, is approximately 19.96 nm-269.93 nm.

The thickness of each of the first material layers in the bandpass filtering structure 20, for example, but not limited to, is approximately 0.02-10.28 times the thickness of the second material layer.

In the bandpass filtering structure 20, the thickness of the respective first material layers, for example, but not limited to, is approximately 0.04-9.43 times or 0.07-4.37 times a thickness of one of the second material layers adjacent to the respective first material layers.

Taking N=57 as an example, the materials and thicknesses of the respective film layers in the bandpass filtering structure 20 are shown in Table 1.

TABLE 1

| film layer# | material | thickness (nm) |
|---|---|---|
| 1 | SiO₂ | 30.00 |
| 2 | Si—H | 19.96 |
| 3 | SiO₂ | 71.04 |
| 4 | Si—H | 94.41 |
| 5 | SiO₂ | 46.04 |
| 6 | Si—H | 49.74 |
| 7 | SiO₂ | 205.21 |
| 8 | Si—H | 21.76 |
| 9 | SiO₂ | 81.25 |
| 10 | Si—H | 127.69 |
| 11 | SiO₂ | 110.48 |
| 12 | Si—H | 35.04 |
| 13 | SiO₂ | 109.22 |
| 14 | Si—H | 163.95 |
| 15 | SiO₂ | 24.91 |
| 16 | Si—H | 27.73 |
| 17 | SiO₂ | 121.27 |
| 18 | Si—H | 176.38 |
| 19 | SiO₂ | 91.90 |
| 20 | Si—H | 32.77 |
| 21 | SiO₂ | 136.11 |
| 22 | Si—H | 181.78 |
| 23 | SiO₂ | 107.89 |
| 24 | Si—H | 123.18 |
| 25 | SiO₂ | 14.65 |
| 26 | Si—H | 110.28 |
| 27 | SiO₂ | 25.54 |
| 28 | Si—H | 214.38 |
| 29 | SiO₂ | 149.05 |
| 30 | Si—H | 212.70 |
| 31 | SiO₂ | 15.65 |
| 32 | Si—H | 251.29 |
| 33 | SiO₂ | 137.77 |
| 34 | Si—H | 193.28 |
| 35 | SiO₂ | 36.30 |
| 36 | Si—H | 267.06 |
| 37 | SiO₂ | 114.98 |
| 38 | Si—H | 190.06 |
| 39 | SiO₂ | 57.25 |
| 40 | Si—H | 269.93 |
| 41 | SiO₂ | 87.08 |
| 42 | Si—H | 196.78 |
| 43 | SiO₂ | 79.11 |
| 44 | Si—H | 96.88 |
| 45 | SiO₂ | 30.90 |
| 46 | Si—H | 126.95 |
| 47 | SiO₂ | 40.40 |
| 48 | Si—H | 79.40 |
| 49 | SiO₂ | 5.34 |
| 50 | Si—H | 120.82 |
| 51 | SiO₂ | 179.36 |
| 52 | Si—H | 36.04 |
| 53 | SiO₂ | 80.29 |
| 54 | Si—H | 99.47 |
| 55 | SiO₂ | 72.35 |
| 56 | Si—H | 27.74 |
| 57 | SiO₂ | 30.00 |

From Table 1, it can be seen that in the bandpass filtering structure 20, the film layer closest to the first surface 11 (i.e., film layer 20_1, i.e., the first film layer) and the film layer farthest from the first surface 11 (i.e., film layer 20_1, i.e., the 57th film layer) are both the first material layers; and the thicknesses of the film layer farthest from the first surface 11 and the film layer closest to the first surface 11 in the bandpass filtering structure 20 are both 30 nm.

The anti-reflection structure 30 includes film layers 30_1-30_M, where M is a positive integer greater than or equal to 2, such as, but not limited to, 10. The film layers 30_1-30_M include at least one third material layer and at least one fourth material layer. The material of the third material layer, such as but not limited to, is the same as the material of the first material layer, and the material of the fourth material layer, such as but not limited to, is the same as the material of the second material layer. These third and fourth material layers are stacked along the normal S.

Taking M=10 as example, the materials and thicknesses of the respective film layers in the anti-reflection structure 30 are shown in Table 2.

TABLE 2

| film layer# | material | thickness (nm) |
|---|---|---|
| 1 | SiO₂ | 30.00 |
| 2 | Si—H | 11.51 |
| 3 | SiO₂ | 111.92 |
| 4 | Si—H | 39.50 |
| 5 | SiO₂ | 43.21 |
| 6 | Si—H | 111.33 |
| 7 | SiO₂ | 37.35 |
| 8 | Si—H | 38.55 |
| 9 | SiO₂ | 192.34 |
| 10 | SiO₂ | 30.00 |
| — | — | — |
| — | — | — |

From Table 2, it can be seen that the film layer closest to the second surface 12 (i.e., film layer 30_1, i.e., the first film layer), the film layer furthest away from the second surface 12 (i.e., film layer 30_M, i.e., the tenth film layer), and the film layer second further away from the second surface 12 (i.e., film layer 30_(M−1)), i.e., the ninth film layer) in the anti-reflection structure 30 are all the third material layers; The thicknesses of the film layer closest to the second surface 12 and the film layer farthest from the second surface 12 in the anti-reflection structure 30 are both 30 nm. The setting of the anti-reflection structure 30 helps to improve the transmittance of the two pass bands of the dual pass band filter element.

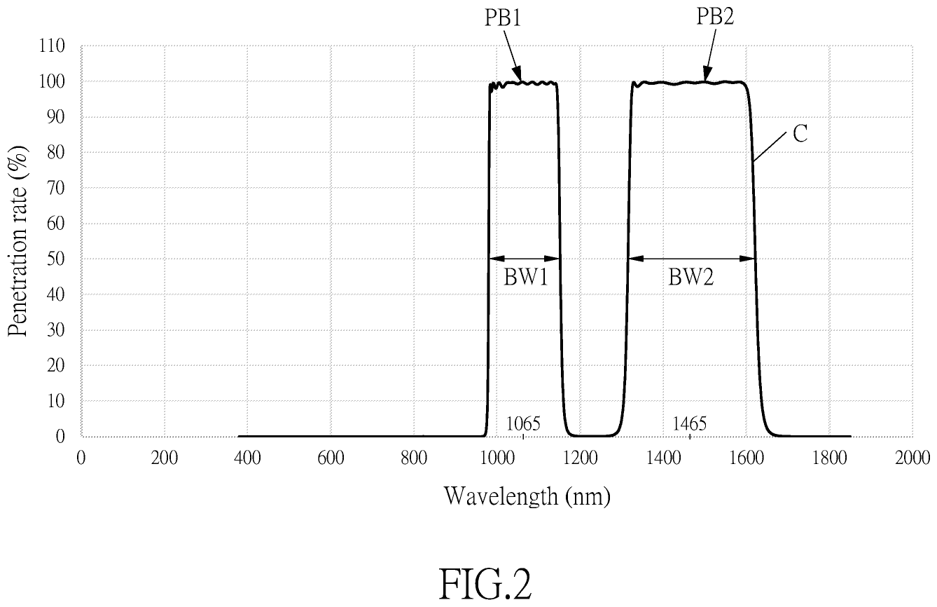

The following is a transmittance simulation test conducted on the dual pass band filter element with the bandpass filtering structure 20 in Table 1 and anti-reflection structure 30 in Table 2, where the dual pass band filter element is placed in an atmospheric environment, and then vertically irradiated (i.e., with an incident angle of 0 degrees) from above (i.e., above in the drawing) with a reference wavelength of 550 nm. The test results are shown with the curve C in FIG. 2.

In FIG. 2, the curve C has a bandwidth BW1 of 170 nm in the corresponding central wavelength of 1065 nm, and the transmittance of this band is as high as 98-99%. Therefore, the light in the band corresponding to this bandwidth BW1 (i.e., the first pass band) can pass through the dual pass band filter element. The curve C has a bandwidth BW2 of 300 nm in the band corresponding to the central wavelength of 1465 nm, and the transmittance of this band is also as high as 98-99%. Therefore, the light in the band corresponding to this bandwidth BW2 (i.e., the second pass band) can pass through the dual pass band filter element, and the light outside the corresponding bands of the bandwidths BW1 and BW2 (i.e., ambient light noise) will be filtered out.

In summary, the dual pass band filter element provided by the present invention can be applied to electronic devices in two different operating bands due to its two bandwidths, which helps to expand its application field. For example, but not limited to, the first pass band corresponding to a center wavelength of 1065 nm can be applied to image sensors for 3D facial recognition, and the second pass band corresponding to a center wavelength of 1465 nm can be applied to thermal image sensors for medical, quarantine, or vehicular purposes.

Although the present invention is disclosed in the aforementioned embodiments, these embodiments are not intended to limit the present invention. All modifications, embellishments, and combinations of various embodiments within the spirit and scope of the present invention are within the scope of protection of the present invention. For the scope of protection defined by the present invention, please refer to the attached scope of claims.

What is claimed is:

1. A dual pass band filter element comprising:
a substrate with a first surface and a second surface opposite the first surface;
a bandpass filtering structure formed on the first surface and including first material layers and second material layers with refractive indexes higher than refractive indexes of the first material layers, wherein the first and second material layers are stacked alternately along a normal of the substrate; and
an anti-reflection structure formed on the second surface;
wherein the dual pass band filter element has a first pass band and a second pass band that does not overlap with the first pass band, in a band of 400 nm to 1800 nm.

2. The dual pass band filter element as claimed in claim 1, wherein in the bandpass filtering structure, a film layer closest to the first surface and a film layer farthest from the first surface are both the first material layers.

3. The dual pass band filter element as claimed in claim 1, wherein a thicknesses of a film layer farthest from the first surface is the same as that of a film layer closest to the first surface in the bandpass filtering structure.

4. The dual pass band filter element as claimed in claim 1, wherein thicknesses of the first material layers in the bandpass filtering structure are 5.34 nm-205.21 nm.

5. The dual pass band filter element as claimed in claim 1, wherein thicknesses of the second material layers in the bandpass filtering structure are 19.96 nm-269.93 nm.

6. The dual pass band filter element as claimed in claim 1, wherein in the bandpass filtering structure, thicknesses of the first material layers are 0.02-10.28 times thicknesses of the second material layers.

7. The dual pass band filter element as claimed in claim 1, wherein in the bandpass filtering structure, a thickness of each of the first material layers is 0.04-9.43 times a thickness of one of the second material layers adjacent to this first material layer.

8. The dual pass band filter element as claimed in claim 1, wherein in the bandpass filtering structure, a thickness of each of the first material layers is 0.07-4.37 times a thickness of one of the second material layers adjacent to this first material layer.

9. The dual pass band filter element as claimed in claim 1, wherein the number of film layers of the bandpass filtering structure is 5.7 times that of the anti-reflection structure.

10. The dual pass band filter element as claimed in claim 1, wherein the anti-reflection structure includes at least one third material layer and at least one fourth material layer, the at least one third material layer and the at least one fourth material layer are stacked along the normal, a material of the third material layer is the same as that of the first material layer, a material of the fourth material layer is the same as that of the second material layer, and in the anti-reflection structure, a film layer closest to the second surface and a film layer farthest from the second surface are both the third material layers.

11. The dual pass band filter element as claimed in claim 1, wherein the anti-reflection structure includes at least one third material layer and at least one fourth material layer, the at least one third material layer and the at least one fourth material layer are stacked along the normal, a material of the third material layer is the same as that of the first material layer, a material of the fourth material layer is the same as that of the second material layer, and in the anti-reflection structure, a thickness of a film layer closest to the second surface is the same as that of a film layer farthest from the second surface.

12. The dual pass band filter element as claimed in claim 3, wherein the anti-reflection structure includes at least one third material layer and at least one fourth material layer, the at least one third material layer and the at least one fourth material layer are stacked along the normal, a material of the third material layer is the same as that of the first material layer, a material of the fourth material layer is the same as that of the second material layer, and in the anti-reflection structure, a thickness of a film layer closest to the second surface is the same as that of a film layer furthest from the second surface.

13. The dual pass band filter element as claimed in claim 1, wherein the anti-reflection structure includes at least one third material layer and at least one fourth material layer, the at least one third material layer and the at least one fourth material layer are stacked along the normal, a material of the third material layer is the same as that of the first material layer, a material of the fourth material layer is the same as that of the second material layer, and a film layer farthest from the first surface and a film layer closest to the first surface in the bandpass filtering structure, and a film layer closest to the second surface and a film layer farthest from the second surface in the anti-reflection structure have a same thickness.

14. The dual pass band filter element as claimed in claim 1, wherein the anti-reflection structure includes at least two third material layers and at least one fourth material layer, the at least two third material layer and the at least one fourth material layers are stacked along the normal, a material of the third material layer is the same as that of the first material layer, a material of the fourth material layer is the same as that of the second material layer, and in the anti-reflection structure, a pair of film layers furthest away from the second surface and stacked together are the third material layers.
